(19) United States
(12) Patent Application Publication
(10) Pub. No.: US 2003/0206308 A1
(43) Pub. Date: Nov. 6, 2003

(54) Image processing method and control method thereof

(75) Inventor: Akihiro Matsuya, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/421,794

(22) Filed: Apr. 24, 2003

(30) Foreign Application Priority Data
May 1, 2002 (JP) 2002-129799

(51) Int. Cl. H04N 1/407; H04N 1/60

(52) U.S. Cl. 358/1.9; 358/518; 358/406; 358/504; 358/3.01; 358/3.23; 358/523

(57) ABSTRACT

A grayscale patch is formed using a uniform density signal on the entire surface of a recording paper sheet corresponding to a print region of a photosensitive drum, and a plurality of such grayscale patches corresponding to different gray levels are output (S3501). The entire surface of each of the plurality of output grayscale patches is scanned by a scanner unit to obtain luminance data for respective pixel positions (S3502). The scanned luminance data for the entire surface are converted into reflection density values using a predetermined table (S3503), and a two-dimensional γ correction LUT corresponding to the print region is obtained on the basis of the converted density values (S3504).

### FIELD OF THE INVENTION

The present invention relates to a control technique of an image processing apparatus and, more particularly, to an image processing apparatus for making grayscale correction on the basis of grayscale patches output by an image forming apparatus, and a control method thereof.

### BACKGROUND OF THE INVENTION

Conventional calibration of a printer engine of a copying machine or printer based on an electrophotography system is done by correcting the grayscale characteristics (γ characteristics) of each color agent of the engine, e.g., each of cyan (C), magenta (M), yellow (Y), and black (K).

FIG. 6 shows an example of grayscale patches which are output to realize desired γ characteristics in the conventional printer engine. Reference numeral 3001 denotes a medium on which grayscale patches are printed, and which is normally a paper sheet or exclusive paper sheet. Reference numerals 3002 to 3005 denote printed C, M, Y, and K grayscale patterns. In this example, patches for 24 gray levels are printed.

FIG. 5 shows the measurement result of the grayscale patches 3001 shown in FIG. 6 using a measurement device (that can obtain density values; not shown). Point A in FIG. 5 represents the density value of a medium, and point B represents the maximum density value to be corrected of a printer. The abscissa of FIG. 5 plots the density signal output to the printer, and the ordinate plots the reflection density measured by the measurement device (not shown). The solid curve in FIG. 5 represents the measured density before correction, and the broken curve represents a target density (grayscale characteristics or γ characteristics) as a target value of correction.

As described above, according to the conventional calibration, grayscale patches used to correct the grayscale characteristics of respective color agents are printed at predetermined positions on a single medium (sheet surface), and are measured to correct γ characteristics to desired characteristics.

In general, with a printer based on an electrophotography system, even when identical density signal values are printed on a medium surface, density values obtained by measuring these values cannot always assume identical reflection density values. Such difference is generated since respective building components (exposure, development, transfer, fixing, and the like) that form the electrophotography system do not have identical characteristics on a two-dimensional print region which is to undergo a print process. Therefore, when the grayscale patches are measured, as described above, the density characteristics vary depending on the printed positions, and corrected characteristics cannot often represent the print characteristics of the printer. In other words, the aforementioned correction method cannot always obtain an optimal calibration result.

### SUMMARY OF THE INVENTION

The present invention has been made to solve the aforementioned problems, and has as its object to provide an image processing apparatus which corrects grayscale characteristics on the basis of formed grayscale patches, and can always implement optimal correction independently of formation positions of the grayscale patches, and a control method thereof.

According to one aspect of the present invention, there is provided an image processing apparatus for forming and outputting an image based on input image data on a recording medium, comprising:

grayscale image output means for forming and outputting images of different gray levels on a plurality of recording media each having a predetermined size;

scanning means for obtaining density information for each predetermined pixel position within an image region of each recording medium by scanning the output images on the plurality of recording media;

color conversion means for converting the scanned density information into color information for correction;

correction data generation means for generating correction data for each predetermined pixel position on the basis of the color information;

holding means for holding the generated correction data; and

image correction means for correcting input image data on the basis of the correction data held by the holding means.

According to another aspect of the present invention, there is provided an image processing apparatus for correcting image data to be input to an image forming apparatus so as to correct output grayscale characteristics onto a recording medium in the image forming apparatus, comprising:

means for obtaining density information for each predetermined pixel position of an image region of each of a plurality of recording media by scanning the recording media on which images of different gray levels are formed by the image forming apparatuses;

means for converting the scanned density information into color information for correction; and

means for generating correction data for each predetermined pixel position on the basis of the color information.

According to still another aspect of the present invention, there is provided a method of controlling an image processing apparatus for forming and outputting an image based on input image data on a recording medium, comprising steps of:

forming and outputting images of different gray levels on a plurality of recording media each having a predetermined size;

obtaining density information for each predetermined pixel position within an image region of each recording medium by scanning the output images on the plurality of recording media;

converting the scanned density information into color information for correction;

generating correction data for each predetermined pixel position on the basis of the color information; and

correcting input image data on the basis of the correction data.

Other features and advantages of the present invention will be apparent from the following descriptions taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the descriptions, serve to explain the principle of the invention.

FIG. 1 is a sectional view of an image forming apparatus in an embodiment of the present invention;

FIG. 2 is a block diagram showing the arrangement of a printer unit in the image forming apparatus of this embodiment;

FIG. 3 is a timing chart showing the image formation timings in the embodiment of the present invention;

FIG. 4 is a block diagram showing the arrangement of an image memory in the embodiment of the present invention;

FIG. 5 shows an example of the grayscale characteristics to be corrected in the embodiment of the present invention;

FIG. 6 shows an example of conventional grayscale patches;

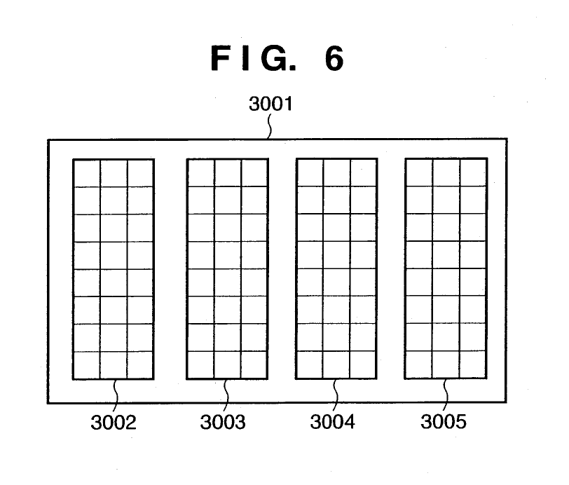

FIG. 7 is a block diagram showing the arrangement of a γ correction circuit in the embodiment of the present invention;

FIG. 8 is a timing chart in the γ correction circuit of the embodiment;

FIG. 9 shows an example of grayscale patches in the embodiment of the present invention;

FIG. 10 is a flow chart showing a grayscale correction process in the embodiment of the present invention;

FIGS. 11A and 11B show examples of a display screen upon outputting/reading grayscale patches in the embodiment of the present invention;

FIG. 12 shows an example of a luminance-density conversion table in the embodiment of the present invention;

FIG. 13 shows an example of the reflection density distribution in the embodiment of the present invention;

FIG. 14 shows an example of a grayscale correction LUT in the embodiment of the present invention;

FIG. 15 shows the concept of the addresses of two-dimensional data in the embodiment of the present invention;

FIG. 16 is a flow chart showing a grayscale correction process in the second embodiment of the present invention; and

FIG. 17 shows an example of sampling regions of grayscale patches in the second embodiment of the present invention.

### DETAILED DESCRIPTION OF THE PREFERRED EMBODIMENTS

Preferred embodiments of the present invention will be described in detail hereinafter with reference to the accompanying drawings.

<First Embodiment>

●Arrangement of Image Forming Apparatus

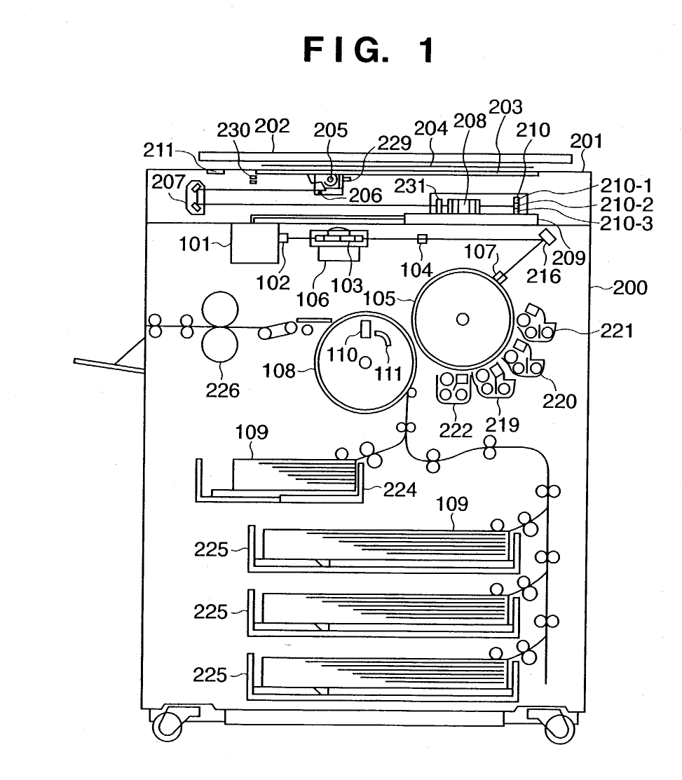

FIG. 1 is a sectional view of an image forming apparatus to which this embodiment is applied. Referring to FIG. 1, reference numeral 201 denotes an image scanner unit, which scans a document, and executes a digital signal process. Reference numeral 200 denotes a printer unit, which prints out in full color a document image scanned by the image scanner unit 201 or an image based on image data transferred from an external apparatus such as a computer or the like (not shown) via a predetermined communication medium.

In the image scanner unit 201, reference numeral 202 denotes a document pressing plate, which presses a document 204 on a platen glass 203 against it. Reference numeral 205 denotes a halogen lamp which irradiates the document 204 on the platen glass 203 with light.

Reference numeral 210 denotes a 3-line sensor (to be referred to as a CCD hereinafter), which comprises a red (R) sensor 210-1, green (G) sensor 210-2, and blue (B) sensor 210-3. The CCD 210 reads R, G, and B components of full-color information by color-separating optical information of light reflected by the document 204, which information is formed on the CCD 210 via mirrors 206 and 207 and a lens 208 having a far infrared cut filter 231.

Reference numeral 209 denotes a signal processor which electrically processes R, G, and B signals read by the R, G, and B sensors 210-1 to 210-3 to separate them into magenta (M), cyan (C), yellow (Y), and black (K) color components, and sends them to the printer unit 200.

Note that the halogen lamp 205 and mirror 206 mechanically move at velocity v and the mirror 7 mechanically moves at velocity v/2 in a direction (to be referred to as a sub-scan direction hereinafter) perpendicular to the electrical scan direction (to be referred to as a main scan direction hereinafter), thus scanning the entire surface of the document 204.

Reference numeral 211 denotes a standard white plate, which has nearly uniform reflection characteristics within the range from visible light to infrared light, and is white under visible light. Using this standard white plate 211, the visible sensor output values of the R, G, and B sensors 210-1 to 210-3 are corrected. Reference numeral 230 denotes an optical sensor which generates an image leading end signal VTOP together with a flag plate 229.

Note that one of M, C, Y, and K components is sent to the printer unit 200 per document scan in the image scanner unit 201, and one printout is formed by a total of four document scans.

In the printer unit 200, reference numeral 101 denotes an image write start timing control circuit, which modulates and drives a semiconductor laser 102 on the basis of M, C, Y, and K image signals input from the image scanner unit 201 or an external apparatus such as a computer or the like (not shown) via a predetermined communication medium. Reference numeral 103 denotes a polygonal mirror which is rotated by a polygon motor 106, and reflects a laser beam emitted by the semiconductor laser 102. The reflected laser beam undergoes f-θ correction by an f-θ lens 104, is reflected by a return mirror 216, and scans the surface of a photosensitive drum 105, thus forming an electrostatic latent image on the photosensitive drum 105.

Reference numeral 107 denotes a BD sensor which is arranged in the vicinity of the 1-line scan start position of the laser beam, and generates a main scan start signal (scan start reference signal of each line in an identical cycle) BD by detecting a line scan of the laser beam. Reference numeral 219 denotes an M developer; 220, a C developer; 221, a Y developer; and 222, a K developer. Each of these developers develops the electrostatic latent image on the photosensitive drum 105 to form a toner image. More specifically, the four developers 219 to 222 alternately contact the photosensitive drum 105 during four revolutions of the latter, and develop M, C, Y, and K electrostatic latent images formed on the photosensitive drum 105 with corresponding toners.

Reference numeral 108 denotes a transfer drum which chucks and conveys a recording paper sheet 109 fed from a paper cassette 224 or 225, and sequentially transfers toner images of respective colors developed on the photosensitive drum 205 onto the recording paper sheet 109.

Reference numeral 110 denotes an ITOP sensor which detects passage of a flag 111 fixed inside the transfer drum 108 upon rotation of the transfer drum 108, and generates a sub-scan start signal (signal that indicates the leading end position of the recording paper sheet 109 chucked on the transfer drum 108) ITOP for each color.

Reference numeral 226 denotes a fixing unit which fixes the toner images transferred onto the recording paper sheet 109 by the transfer drum 108.

●Details of Printer Unit

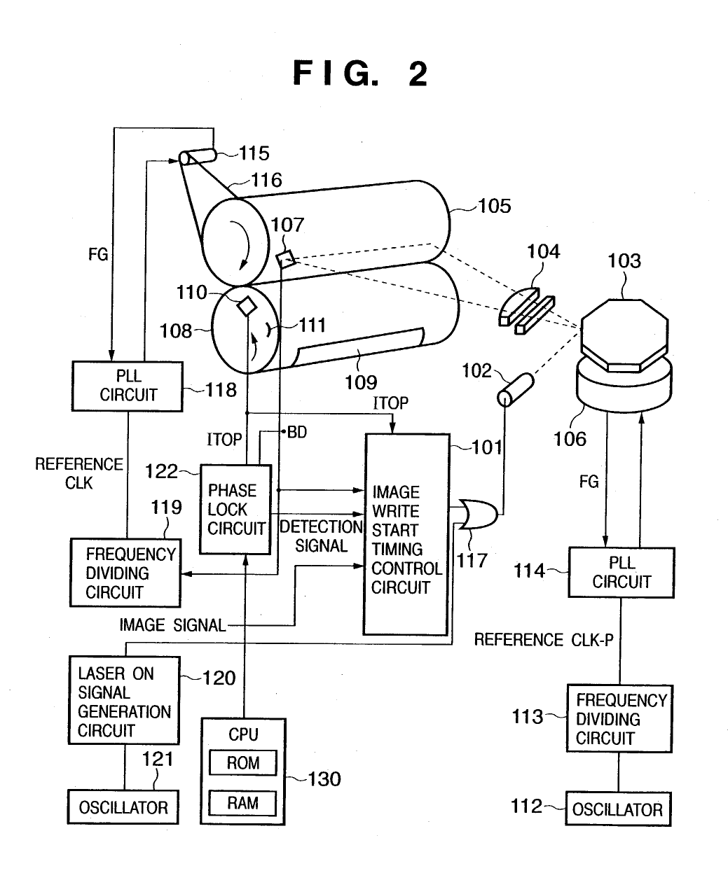

FIG. 2 is a block diagram for explaining the arrangement for forming an electrostatic latent image on the photosensitive drum 105 in the printer unit 200 shown in FIG. 1. The same reference numerals in FIG. 2 denote the same parts as in FIG. 1.

Referring to FIG. 2, reference numeral 112 denotes an oscillator which outputs clocks of a predetermined frequency. Reference numeral 113 denotes a frequency dividing circuit which divides clocks output from the oscillator 112 at a predetermined frequency division ratio to generate polygon motor drive pulses (reference CLK-P). Reference numeral 114 denotes a PLL circuit which controls the drive voltage of the polygon motor 106 on the basis of motor FG pulses output upon rotation of the polygon motor 106, and reference CLK-P.

Reference numeral 121 denotes an oscillator which outputs clocks of a predetermined frequency. Reference numeral 120 denotes a laser ON signal generation circuit, which receives the clocks from the oscillator 121 and a BD signal from the BD sensor 107, and outputs a laser ON signal used to detect the BD signal. Reference numeral 122 denotes a phase lock circuit, which receives an ITOP signal from the ITOP sensor 110, a BD signal from the BD sensor 107, a data load enable signal from a CPU 130, and the like, and delays and outputs the ITOP signal on the basis of the phase difference between the ITOP signal and BD signal. That is, the circuit 122 locks the phases of the ITOP signal and BD signal.

Reference numeral 101 denotes an image write start timing control circuit, which receives the ITOP signal output from the phase lock circuit 122, and outputs an image signal at a timing synchronized with the ITOP signal. Reference numeral 117 denotes an OR gate which outputs the image signal from the image write start timing control circuit 101 or the laser ON signal used to detect the BD signal from the laser ON signal generation circuit 120 to the semiconductor laser 102, and modulates and drives the semiconductor laser 102.

Reference numeral 119 denotes a frequency dividing circuit which divides the BD signal from the BD sensor 107 at a predetermined frequency division ratio to generate photosensitive drum motor drive pulses (reference CLK). Reference numeral 118 denotes a PLL circuit which controls the drive voltage to be supplied to a photosensitive drum motor 115 on the basis of motor FG pulses output upon rotation of the photosensitive drum motor 115, and reference CLK. Note that the CPU 130 includes a ROM and RAM, and systematically controls the entire image forming apparatus on the basis of a program stored in the ROM.

The operations of the respective units shown in FIG. 2 will be described in detail below.

Image signals transferred from the image scanner unit 201 shown in FIG. 1 or an external apparatus such as a computer or the like (not shown) via a predetermined communication medium are supplied to the image write start timing control circuit 101, which modulates and drives the semiconductor laser 102 in accordance with the M, C, Y, and K image signals via the OR gate 117.

A laser beam is reflected by the rotating polygonal mirror 103, and scans the surface of the photosensitive drum 105 via the f-θ lens (and return mirror 216), thus forming an electrostatic latent image on the photosensitive drum 105.

The polygon motor drive pulses (reference CLK-P), which are generated by dividing the clocks from the oscillator 112 by the frequency dividing circuit 113 are supplied to the PLL circuit 114. The PLL circuit 114 makes PLL control that controls the drive voltage to be supplied to the polygon motor 106 by detecting the phase difference and frequency deviation between the FG pulses and reference CLK-P to lock the phases of the motor FG pulses from the polygon motor 106 and reference CLK-P, and comparing them.

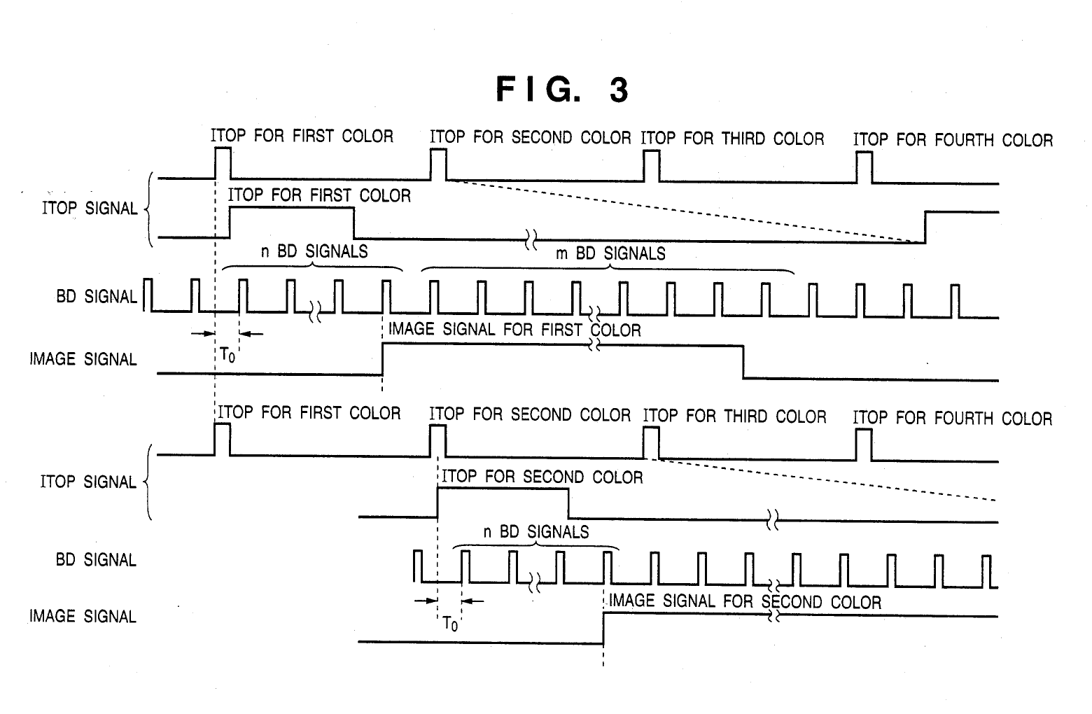

The BD sensor 107 arranged in the vicinity of the 1-line scan start position of a laser beam detects a line scan of the laser beam, and generates a scan start reference signal (BD signal) for each line in an identical cycle, as shown in FIG. 3 (to be described later). The ITOP sensor 110 in the transfer drum 108 generates an ITOP signal (signal that indicates the leading end position of the recording paper sheet 109 on the transfer drum 108) for each color, as shown in FIG. 3 (to be described later), by detecting the flag 111 fixed in the transfer drum 108 upon rotation of the transfer drum 108. Furthermore, the photosensitive drum motor 115 is rotated by supplying the motor drive pulses (reference CLK) obtained by frequency-dividing the laser ON signal used to detect a BD signal from the laser ON signal generation circuit 120 by the frequency dividing circuit 119 to the PLL circuit 118.

The PLL circuit 118 makes PLL control that controls the drive voltage to be supplied to the photosensitive drum motor 115 by detecting the phase difference and frequency deviation between the FG pulses and reference CLK to lock the phases of the motor FG pulses from the photosensitive drum motor 115 and reference CLK, and comparing them. The photosensitive drum 105 rotated in the direction of an arrow in FIG. 2 by the photosensitive drum motor 115 via a gear belt 116. The transfer drum 108 is rotated in the direction of an arrow in FIG. 2 (sub-scan direction) in synchronism with the photosensitive drum 105 and at the same velocity as the photosensitive drum 105 since it is coupled to the photosensitive drum 105 via gears (not shown).

These BD signal and ITOP signal are input to the image write start timing control circuit 101, which outputs an image signal to the semiconductor laser 102 at the following timing. That is, upon detection of the leading edge of the ITOP signal, the image write start timing control circuit 101 counts a predetermined number of BD signals, generates a sub-scan start signal (for m BD signals determined depending on the length of the recording paper sheet 109) in synchronism with the leading edge of the n-th BD signal, and irradiates the photosensitive drum 105 with the image signal as a modulated laser beam.

FIG. 3 is a timing chart showing the image formation timings of the printer unit 200 in the image forming apparatus shown in FIG. 1.

Referring to FIG. 3, the ITOP signal is output when the ITOP sensor 110 detects the flag 111 fixed in the transfer drum 108 upon rotation of the latter. The ITOP signal indicates the leading end position of the recording paper sheet 109 on the transfer drum 108, and is output for each color.

The BD signal is output when the BD sensor 107 arranged in the vicinity of the 1-line scan start position of a laser beam detects a line scan of the laser beam. The BD signal is a scan start reference signal for each line in an identical cycle.

The image signal is output to the semiconductor laser 102 via the OR gate 117 in synchronism with the n-th BD signal since the BD signal and ITOP signal are input to the image write start timing control circuit 111 and, for example, the leading edge of the ITOP signal is detected. That is, the circuit 101 generates a sub-scan start signal in synchronism with the leading edge of the n-th (predetermined value) BD signal after detection of the leading edge of the ITOP signal, and irradiates the photosensitive drum 105 with the image signal as a modulated laser beam for m BD signals.

In this embodiment, an integral number of BD signals are just output per revolution of the photosensitive drum 105, so that a laser scan line is always located at the same position on the photosensitive drum 105 for respective revolutions. For example, the number of BD signals output per revolution of the photosensitive drum, which is determined on the basis of the process speed and resolution, is 8192.

The photosensitive drum 105 has a gear ratio such that it revolves once per 64 revolutions of the photosensitive drum motor 115, and the photosensitive drum motor 115 requires 32 FG pulses per revolution. Hence, the photosensitive drum motor 115 requires 32 reference clock pulses per revolution.

Therefore, the photosensitive drum 105 requires 64 revolutions×32 reference clock pulses, i.e., 2048 pulses per revolution. For this purpose, since clock pulses obtained by frequency-dividing the BD signal to ¼ are used as the reference CLK of the photosensitive drum motor 115, the photosensitive drum 105 makes one revolution when 8192 BD signals are output.

Note that this gear ratio is designed to have a natural number. By rotating the motor and reduction gears an integral number of times per revolution of the photosensitive drum 105, the influences of eccentricity of the motor shaft and reduction gears always equally appear for respective revolutions of the photosensitive drum 105, thereby removing color misregistration caused by such decentering.

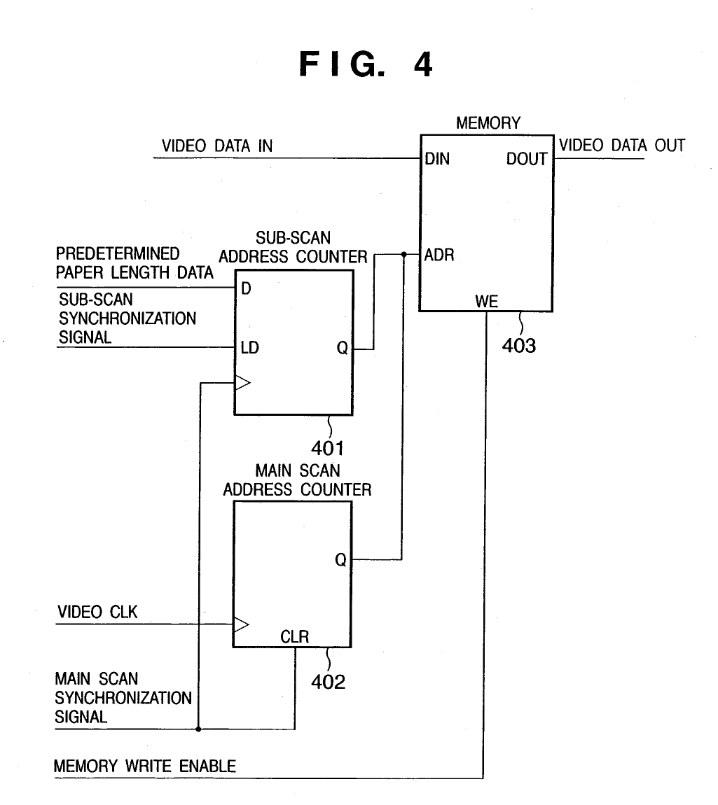

Note that the printer unit 200 forms an image on the basis of an image signal transferred from the image scanner unit 201 or an external apparatus such as a computer or the like (not shown) via a predetermined communication medium. For this purpose, the image write start timing control circuit 101 in the printer unit 200 has an image memory. FIG. 4 shows the block arrangement of the image memory.

Referring to FIG. 4, reference numeral 401 denotes a sub-scan address counter, which counts read synchronization signals (reader LSYNC), and supplies addresses for one line to a memory 403. This counter loads a count value corresponding to a predetermined paper length in response to the sub-scan synchronization signal ITOP, down-counts the count value in response to each reader LSYNC since input of the sub-scan synchronization signal ITOP, and supplies sub-scan addresses of image data.

Reference numeral 402 denotes a main scan address counter which is cleared in response to each reader LSYNC of a main scan synchronization signal for one line, counts video CLK, and supplies addresses for respective pixels to the memory 403.

The memory 403 reads/writes image data on the basis of the addresses supplied from the counters 401 and 402. In both read and write modes, reader LSYNC is an identical signal, and is synchronized with the BD signal. A write enable signal is supplied to the memory 403 by setting an enable terminal (WE terminal) of the memory 403 to “H” by a CPU (not shown).

●Details of Signal Processor

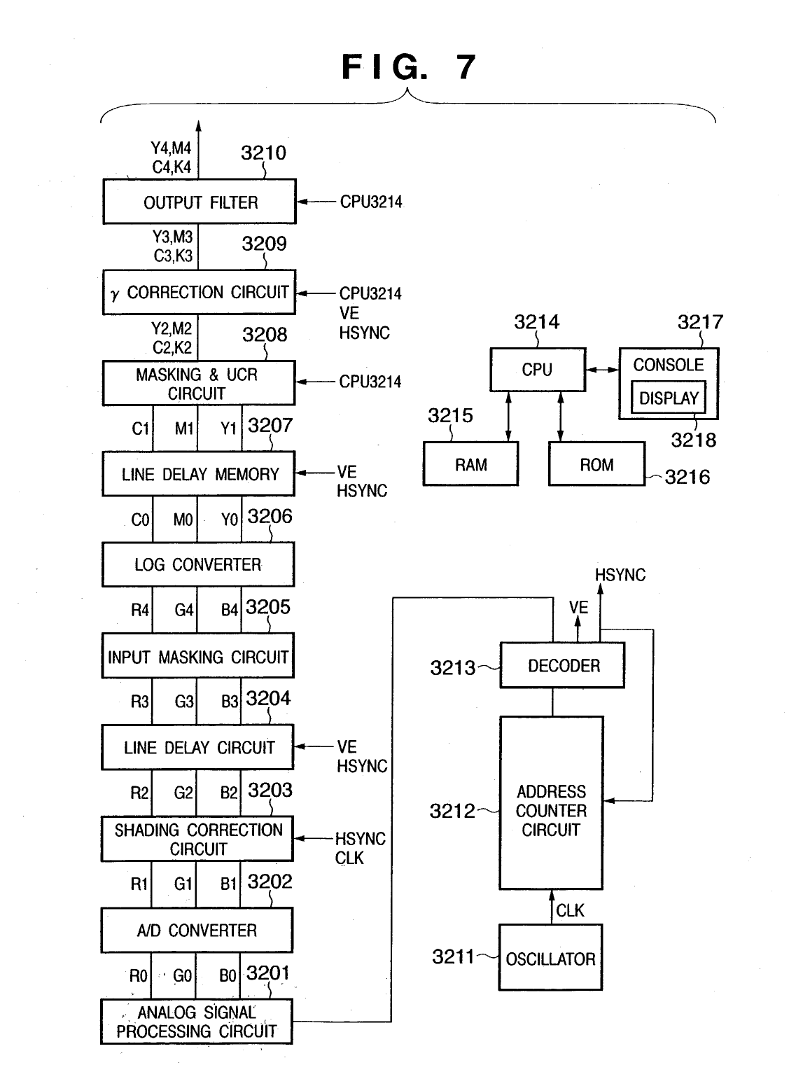

FIG. 7 shows the detailed arrangement of the signal processor 209 in the image scanner unit 201. Details of the signal processor 209 will be described below with reference to FIG. 7.

Referring to FIG. 7, an oscillator 3211 generates clocks (CLK) for respective pixels. A main scan address counter 3212 counts these clocks to output pixel addresses (main scan addresses) for one line. A decoder 3213 decodes the main scan address to generate CCD drive signals for each line such as shift pulses, reset pulses, and the like, a VE signal indicating an effective range in a 1-line read signal from the CCD, and a line synchronization signal HSYNC. Note that the main scan address counter 3212 is cleared in response to the HSYNC signal, and starts counting of main scan addresses for the next line.

An analog signal processing circuit 3201 drives the CCD sensors 210-1 to 210-3 on the basis of the CCD drive signals, and reads analog signals R0, G0, and B0 from reflected light of a document image, which is formed on these sensors. These analog signals are converted by an A/D converter 3202 into digital signals R1, G1, and B1, which undergo known shading correction based on HSYNC and CLK in a shading correction circuit 3203, thus outputting digital signals P2, G2, and B2.

Since line sensors of the CCD sensors 210-1 to 210-3 are arranged to be spaced a predetermined distance from each other, spatial deviations in the sub-scan direction are corrected by a line delay circuit 3204. More specifically, the circuit 3204 line-delays R and G signals with respect to a B signal in the sub-scan direction to align them with the B signal.

An input masking unit 3205 converts a read color space determined by the spectral characteristics of R, G, and B filters of the CCD sensors 210-1 to 210-3 into an NTSC standard color space. More specifically, the unit 3205 makes matrix operations given by:

$$[ \begin{matrix}R4 \\ G4 \\ B4\end{matrix} ] = [ \begin{matrix}a11 & a12 & a13 \\ a21 & a22 & a23 \\ a31 & a32 & a33\end{matrix} ] [ \begin{matrix}R3 \\ G3 \\ B3\end{matrix} ]$$

where coefficients a11 to a33 are conversion coefficients used to convert the color space.

A light amount/density converter (LOG converter) 3206 comprises a look-up table ROM, which converts luminance signals R4, G4, and B4 into density signals C0, M0, and Y0. A line delay memory 3207 delays image signals C0, M0, and Y0 for a line delay until determination signals (FILTER, SEN, and the like) are generated based on signals R4, G4, and B4 by a black character determination unit (not shown), and outputs signals C1, M1, and Y1.

A masking & UCR (Under Color Removal) circuit 3208 extracts a black signal (K) from the input three primary color signals C1, M1, and Y1, makes arithmetic operations for correcting color fog of recording color agents, and outputs signals Y2, M2, C2, and K2 with a predetermined bit width (e.g., 8 bits) in turn for respective operations.

A γ correction circuit 3209 makes density correction (grayscale characteristic correction control) to adjust image signals Y2, M2, C2, and K2 input using the scanner unit 201 to ideal grayscale characteristics of the printer unit 200, and outputs signals Y3, M3, C3, and K3. This grayscale characteristic correction control is a characteristic feature of this embodiment, and its result is reflected in the γ correction circuit 3209, as will be described later. Furthermore, a spatial filter processor (output filter) 2110 makes an edge emphasis or smoothing process for input image signals Y3, M3, C3, and K3, and outputs signals Y4, M4, C4, and K4.

Frame-sequential image signals M4, C4, Y4, and K4, which have been processed in the signal processor 209, as described above, are sent to the printer unit 200, and undergo PWM (pulse-width modulation) density recording.

Note that reference numeral 3214 in FIG. 7 denotes a CPU which controls the scanner unit 201; 3215, a RAM; and 3216, a ROM. Reference numeral 3217 denotes a console, which has a display 3218.

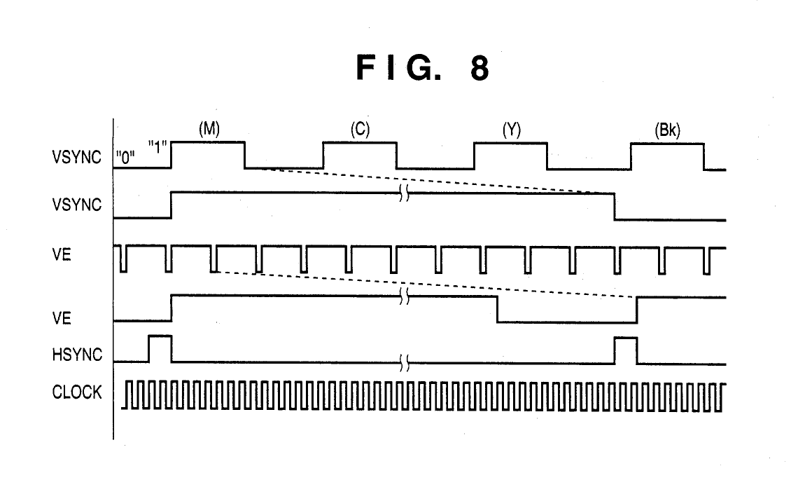

FIG. 8 is a timing chart of respective control signals in the signal processor 209 shown in FIG. 7. Referring to FIG. 8, a VSYNC signal is an image effective period signal in the sub-scan direction, and is used to scan an image during a period of logic “1”, thus sequentially forming output signals M, C, Y, and K. A VE signal is an image effective period signal in the main scan direction, specifies the timing of the main scan start position during a period of logic “1”, and is mainly used in line count control for line delay. A CLOCK signal is a pixel synchronization signal, and is used to transfer image signal at a leading edge timing from “0”→“1”.

●Grayscale Characteristic Control

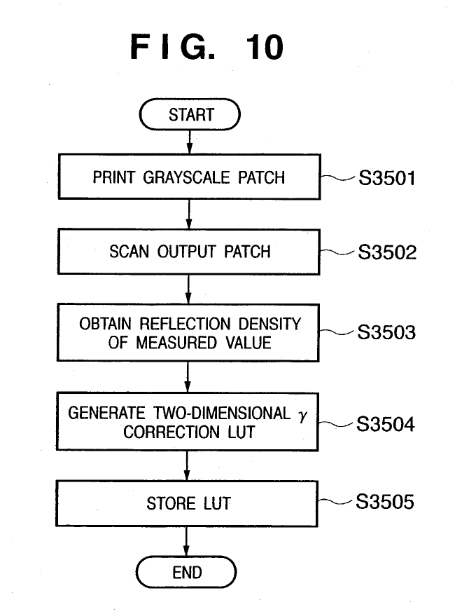

The grayscale characteristic control as a characteristic operation in the image forming apparatus of this embodiment with the aforementioned arrangement will be described below with reference to the flow chart in FIG. 10.

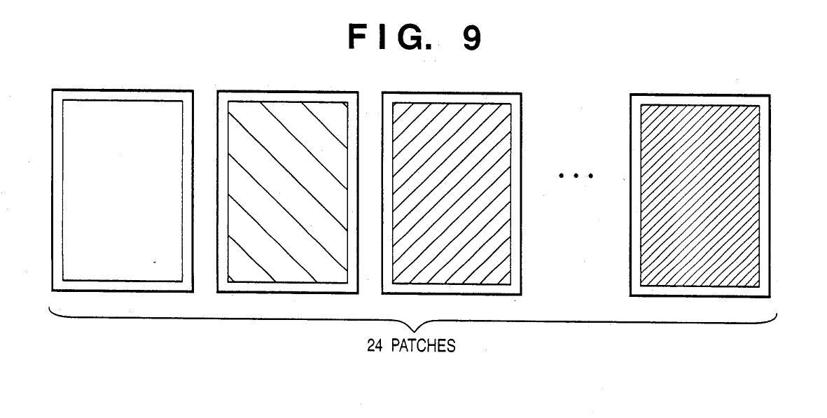

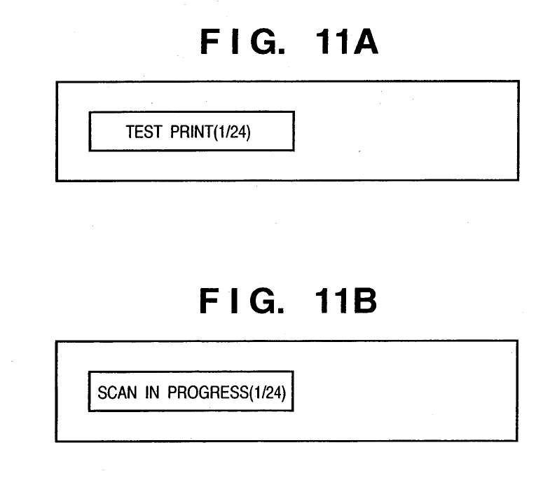

Predetermined patches used to measure the grayscale characteristics of the printer unit 200 are output (S3501). FIG. 9 shows an example of the predetermined patches for measurement. Each of grayscale patches shown in FIG. 9 is prepared by forming (printing) an image on the entire effective image region on an A3-size recording paper sheet using a uniform density signal, and patches for a total of 24 gray levels are prepared. This embodiment is premised on that the circumference of the photosensitive drum 105 corresponds to an A3-size print region. Hence, if the drum diameter is smaller than that of this embodiment, a print region corresponding to the drum diameter is set and printed on an A3-size recording paper sheet. In this embodiment, 24 A3 images are printed using 24 different density signals from a full-surface highlight port to a full-surface dark part in turn from the left in FIG. 9. Upon printing these images, a print instruction shown in FIG. 11A is displayed on the display 3218 of the console 3217, and grayscale patches are printed out in turn from a grayscale patch indicating highlight (left end in FIG. 9).

Each of the output grayscale patches is placed on the platen glass 203 of the scanner unit 201, and its full surface is scanned (S3502). During the scan, a message indicating that the scan is in progress is displayed on the display 3218, as shown in FIG. 11B. In this embodiment, 24 A3-size grayscale patches are printed, and their full surfaces are scanned by the scanner unit 201 as luminance data. Note that this scan process obtains luminance data at a position corresponding to the read resolution of the scanner unit 201 on each A3-size grayscale patch.

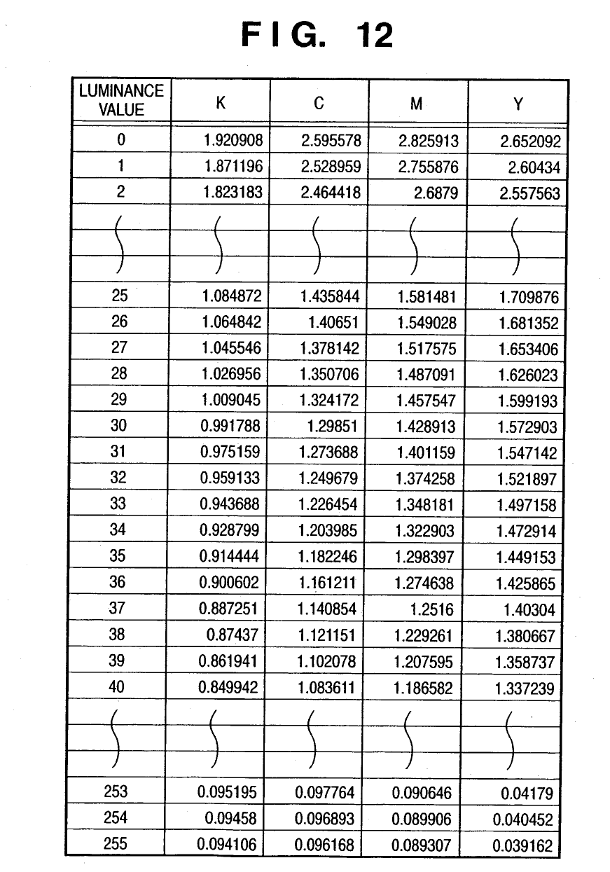

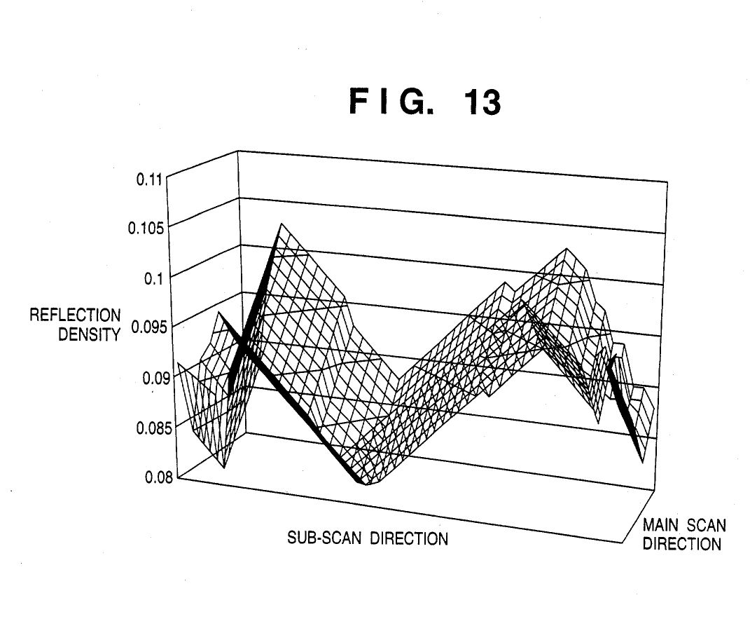

The scanned 24 A3-size luminance data are temporarily stored in the RAM 3215, and are converted into C, M, Y, and K reflection density values by the CPU 3214 using a luminance-density conversion table prepared in advance in the ROM 3216 (S3503). Note that this embodiment adopts STATUS-A as a density conversion filter. FIG. 12 shows an example of the luminance-density conversion table. FIG. 13 shows an example of the two-dimensional density distribution, which is converted by this luminance-density conversion table, and is assumed in this embodiment. Note that FIG. 13 merely shows an example of the density distribution, and actual measured values do not always form such distribution.

With the aforementioned processes, the RAM 3215 consequently stores density data for 24 gray levels in correspondence with the full image formation region (corresponding to an A3 size) of the photosensitive drum 105.

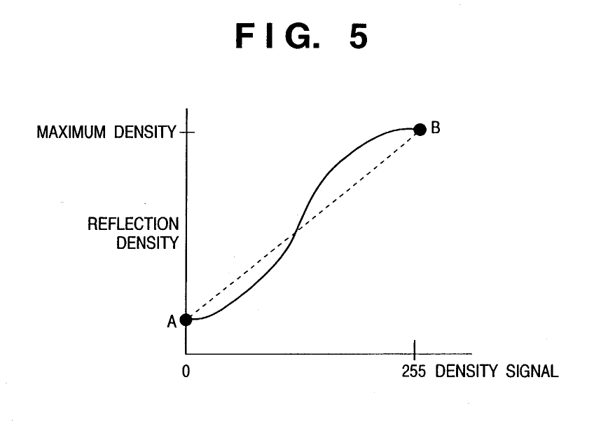

FIG. 5 shows an example of the grayscale characteristics (γ characteristics) to be corrected. The abscissa in FIG. 5 plots the density signal (0 to 255), and the ordinate plots the reflection density value obtained by the above luminance-density conversion. Point A in FIG. 5 represents the density value of a medium, and point B represents the maximum density value to be corrected of the printer unit 200. Broken curve A-B represents a grayscale curve to be obtained, i.e., ideal γ characteristics after correction, and the solid curve represents measured density values at arbitrary pixel positions, i.e., γ characteristics before correction. Note that the ideal γ characteristics indicated by the broken curve are pre-stored in the ROM 3216, and are loaded onto the RAM 3215 by the CPU 3214 upon generation of γ correction data.

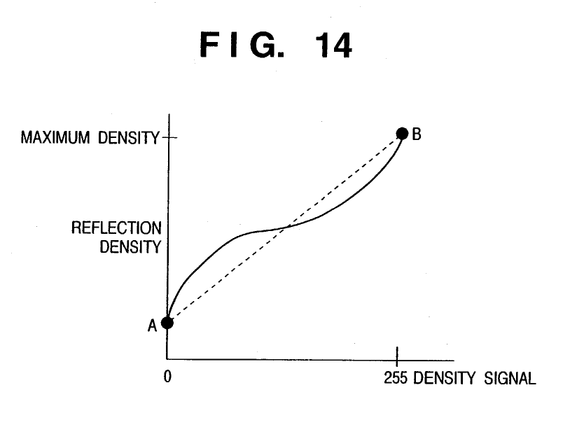

Respective pieces of pixel information, which form the two-dimensional density distribution obtained in step S3503, are temporarily stored in the RAM 3215. The CPU 3214 obtains a γ correction LUT shown in, e.g., FIG. 14 using a known interpolation technique (spline interpolation, linear interpolation, or the like) for respective pixels on the basis of the ideal γ characteristics (broken curve in FIG. 5), which are temporarily pre-stored at a predetermined address in the RAM 3215 (S3504). Note that FIG. 14 shows γ characteristics at arbitrary pixel positions. Hence, in this embodiment, γ correction LUTs must be similarly generated for pixels in a required print region, i.e., pixels corresponding to all read positions. Note that the broken curve in FIG. 14 represents the ideal γ characteristics as in FIG. 5, and the solid curve represents the obtained γ correction LUT.

With the aforementioned sequence, a two-dimensional γ correction LUT corresponding to the image formation region of the photosensitive drum 105 is generated, and is stored in the RAM 3215 (S3505). In order to maintain the generated γ correction LUT even after power OFF, the generated LUT can be stored in a RAM which is backed up by electric power supplied from a battery or the like, a hard disk (HDD), or the like. The γ correction LUT which is generated and held in this way is looked up by the γ correction circuit 3209 shown in FIG. 7.

The grayscale correction process using the two-dimensional γ correction LUT obtained in this way will be explained below.

The γ correction circuit 3209 shown in FIG. 7 corrects 8-bit signals M2, C2, Y2, and K2 generated by the masking & UCR circuit 3208 using the γ correction LUT to obtain desired grayscale characteristics of the printer engine.

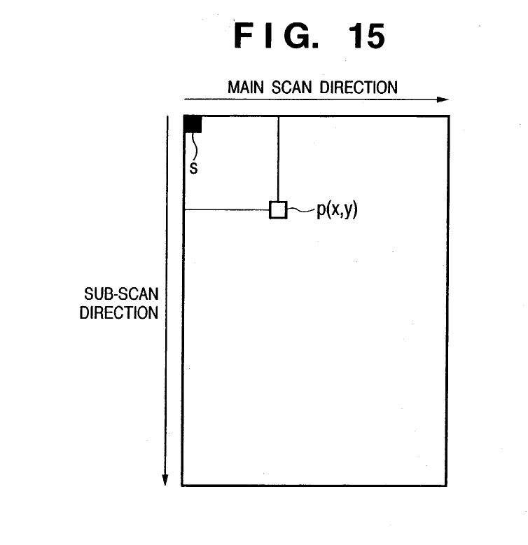

The γ correction circuit 3209 recognizes the addresses of an image to be processed on the basis of the HSYNC signal and VE signal output from the decoder 3213. FIG. 15 shows the concept of an image space to be processed. If an upper left pixel position “s” in FIG. 15 is defined as an origin, this image space indicates an address space which serves as a reference on the drum surface of the aforementioned photosensitive drum 105. That is, each pixel position p(x, y) to be processed by the γ correction circuit 3209 represents one of density signals C, M, Y, and K when the pixel position (address) to be processed is x in the main scan direction and y in the sub-scan direction.

The CPU 3214 calls a γ correction table corresponding to the pixel position (x, y) from the two-dimensional γ correction LUT stored in the RAM 3215 in accordance with address (x, y) analyzed by the decoder 3213 shown in FIG. 7, and changes density signals Y2, M2, C2, and K2 in accordance with the LUT to obtain predetermined grayscale characteristics. Changed 8-bit density signals M3, C3, Y3, and K3 are output to the subsequent output filter 3210.

In this embodiment, the scanner unit 201 attached to the image forming apparatus is used as a device for scanning grayscale patches. Alternatively, values scanned using another scanning device (scanner, densitometer, color meter, or spectral calorimeter) connected via a communication medium (not shown) may be used.

In this embodiment, the full surface of the print region is scanned. Also, this embodiment is similarly implemented when a predetermined number of sampling points within the region is scanned.

As described above, according to this embodiment, since grayscale correction LUTs corresponding to respective positions on an image carrier, on which an image is formed, can be generated, high-precision correction corresponding to pixel positions on the image carrier can be realized compared to the conventional grayscale correction process.

Hence, image quality deterioration resulting from any nonuniformity and density difference within a frame, which cannot be satisfactorily corrected by the conventional technique, can be suppressed.

<Second Embodiment>

The second embodiment according to the present invention will be described below. Note that the same reference numerals in an image forming apparatus of the second embodiment denote the same parts as those in the first embodiment, and a description thereof will be omitted.

In the first embodiment mentioned above, a two-dimensional γ correction LUT is calculated at all pixel positions within the print region. In the second embodiment, a method of calculating a two-dimensional γ correction LUT of a given print region on the basis of measurement points sampled within the print region will be explained.

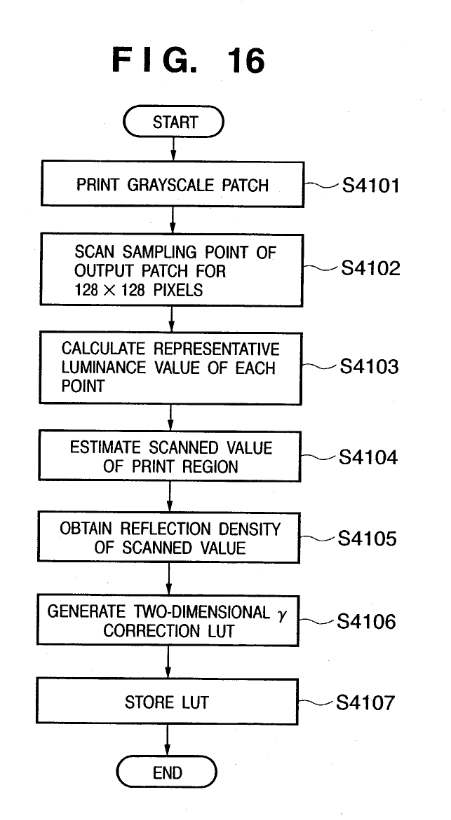

FIG. 16 is a flow chart showing a two-dimensional γ correction LUT generation process in the second embodiment.

As in the first embodiment, a plurality of grayscale patches (FIG. 9), each of which has the same size as the print region of the photosensitive drum 105, are output (S4101).

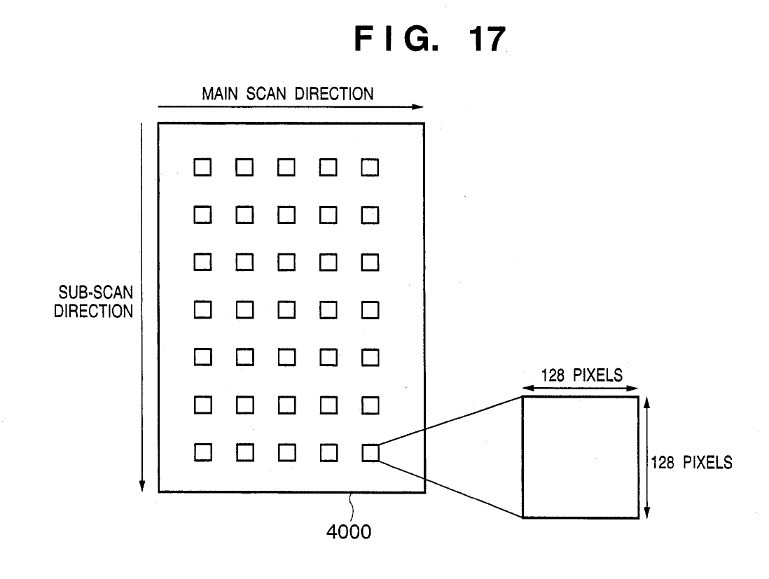

Subsequently, luminance values are measured at sampling points (a total of 35 points=5 points in the main scan direction×7 points in the sub-scan direction) indicated as a plurality of square regions in FIG. 17 (S4102). Note that the number of sampling points is not limited to 35, and can be changed in accordance with the characteristics of the printer unit 200. At each measurement point, luminance values for, e.g., 128×128 pixels are measured, as shown in FIG. 17, in place of measuring that of only one pixel. At each point, the average value of the scanned luminance values for 128×128 pixels is calculated to obtain a representative value of that point (S4103).

The luminance value of the entire print region is estimated on the basis of the obtained representative values of the sampling points (S4104). As the method of estimating the luminance value, the scanned value of an entire print region 4000 is estimated by interpolation and/or extrapolation of a known linear interpolation process on the basis of the 35 sampling points.

The estimated scanned value is converted into C, M, Y, and K reflection density values using the conversion table shown in FIG. 12 as in the first embodiment (S4105).

After that, a two-dimensional γ correction LUT of respective pixels in the print region is generated (S4106), and is stored in the RAM 3215 (S4107), as in the first embodiment.

As described above, according to the second embodiment, since each grayscale patch is scanned not in correspondence with the entire print region, the time required to generate the γ correction LUT can be shortened compared to the first embodiment.

As described above, according to the present invention, upon correcting the grayscale characteristics on the basis of formed grayscale patches, optimal correction can always be implemented independently of forming positions of the grayscale patches.

The present invention is not limited to the above embodiments and various changes and modifications can be made within the spirit and scope of the present invention. Therefore, to apprise the public of the scope of the present invention, the following claims are made.

What is claimed is:

1. An image processing apparatus for forming and outputting an image based on input image data on a recording medium, comprising:
grayscale image output means for forming and outputting images of different gray levels on a plurality of recording media each having a predetermined size;
scanning means for obtaining density information for each predetermined pixel position within an image region of each recording medium by scanning the output images on the plurality of recording media;
color conversion means for converting the scanned density information into color information for correction;
correction data generation means for generating correction data for each predetermined pixel position on the basis of the color information;
holding means for holding the generated correction data; and
image correction means for correcting input image data on the basis of the correction data held by said holding means.

2. The apparatus according to claim 1, wherein said grayscale image output means forms an image on an effective image region of each recording medium using a uniform density signal.

3. The apparatus according to claim 1, wherein said grayscale image output means transfers and outputs a grayscale image formed on an image carrier onto each recording medium, and
said correction data generation means generates the correction data for each pixel position in correspondence with an absolute position on the image carrier.

4. The apparatus according to claim 3, wherein each recording medium used in said grayscale image output means has a size corresponding to an effective image region on the image carrier.

5. The apparatus according to claim 1, wherein said correction data generation means generates the correction data as a two-dimensional lookup table.

6. The apparatus according to claim 1, wherein said correction data generation means generates the correction data by comparing the color information with predetermined grayscale characteristics.

7. The apparatus according to claim 1, wherein said scanning means includes:
partial scanning means for obtaining density information for each pixel position from a plurality of partial regions on each of the recording media output by said grayscale image output means;
representative value determination means for determining a representative value of the density information for each of the partial regions; and
estimation means for estimating density information for each predetermined pixel position in an image region of the corresponding recording medium on the basis of a plurality of determined representative values.

8. The apparatus according to claim 7, wherein said representative value determination means determines an average value of density information in each partial region as the representative value.

9. The apparatus according to claim 7, wherein said estimation means estimates the density information for each predetermined pixel position in the image region by a linear interpolation process based on the representative values for respective partial regions.

10. An image processing apparatus for correcting image data to be input to an image forming apparatus so as to correct output grayscale characteristics onto a recording medium in the image forming apparatus, comprising:
means for obtaining density information for each predetermined pixel position of an image region of each of a plurality of recording media by scanning the recording media on which images of different gray levels are formed by the image forming apparatuses;
means for converting the scanned density information into color information for correction; and
means for generating correction data for each predetermined pixel position on the basis of the color information.

11. A method of controlling an image processing apparatus for forming and outputting an image based on input image data on a recording medium, comprising steps of:
forming and outputting images of different gray levels on a plurality of recording media each having a predetermined size;
obtaining density information for each predetermined pixel position within an image region of each recording medium by scanning the output images on the plurality of recording media;
converting the scanned density information into color information for correction;
generating correction data for each predetermined pixel position on the basis of the color information; and
correcting input image data on the basis of the correction data.

12. A program for controlling an image processing apparatus for forming and outputting an image based on input image data on a recording medium, said program making the apparatus execute steps of:
forming and outputting images of different gray levels on a plurality of recording media each having a predetermined size;
obtaining density information for each predetermined pixel position within an image region of each recording medium by scanning the output images on the plurality of recording media;
converting the scanned density information into color information for correction;
generating correction data for each predetermined pixel position on the basis of the color information; and
correcting input image data on the basis of the correction data.

13. A storage medium storing a program for controlling an image processing apparatus for forming and outputting an image based on input image data on a recording medium, said program making the apparatus execute steps of:
forming and outputting images of different gray levels on a plurality of recording media each having a predetermined size;
obtaining density information for each predetermined pixel position within an image region of each recording medium by scanning the output images on the plurality of recording media;
converting the scanned density information into color information for correction;
generating correction data for each predetermined pixel position on the basis of the color information; and
correcting input image data on the basis of the correction data.
